(19) United States
(12) Patent Application Publication
(10) Pub. No.: US 2012/0296696 A1
(43) Pub. Date: Nov. 22, 2012

(54) SUSTAINING ENGINEERING AND MAINTENANCE USING SEM PATTERNS AND THE SEMINAL DASHBOARD

(75) Inventors: Murray R. Cantor, Westwood, MA (US); Robert M. Delmonico, White Plains, NY (US); Mila Keren, Nesher (IL); Peter K. Malkin, Ardsley, NY (US); Paul M. Matchen, Bethel, CT (US); Peri L. Tarr, Hawthorne, NY (US); Sergey Zeltyn, Haifa (IL)

(73) Assignee: INTERNATIONAL BUSINESS MACHINES CORPORATION, Armonk, NY (US)

(21) Appl. No.: 13/399,015

(22) Filed: Feb. 17, 2012

Related U.S. Application Data
(60) Provisional application No. 61/486,940, filed on May 17, 2011.

(51) Int. Cl. G06Q 10/06

(52) U.S. Cl. 705/7.28

(57) ABSTRACT

Supporting problem resolution of an organization, in one aspect, may include obtaining operational data associated with the organization, calculating operating metrics based on the operational data, detecting one or more metrics trends based on the calculated operational metrics, identifying one or more relations between the metric trends, and determining one or more SEM patterns from two or more of the calculated operational metrics and metric trends.

### CROSS-REFERENCE TO RELATED APPLICATIONS

This application claims the benefit of U.S. Provisional Application No. 61/486,940 filed on May 17, 2011, which is incorporated by reference herein in its entirety.

### FIELD

The present application relates generally to computers, and computer applications, and more particularly to sustaining engineering and maintenance using patterns.

### BACKGROUND

Computer system related components and software have defects associated with them even after they are sold or shipped to customers. Sustaining engineering and maintenance (SEM) business processes are put in place to fix defects and make other relatively small enhancements to address immediate end-user issues. The cost of SEM processes can be the difference between profit and loss for organizations; high after-delivery costs lead directly to losses on software or other components sold. SEM processes thus can control after-market expenses. To be profitable, SEM processes should have efficiency. The faster a SEM organization can close customer issues, the lower the after-market costs and the more profit it can earn.

### BRIEF SUMMARY

A method for supporting problem resolution of an organization, in one aspect, may include obtaining operational data associated with the organization. The method may also include calculating operating metrics based on the operational data. The method may further include detecting one or more metrics trends based on the calculated operational metrics. The method may yet further include identifying one or more relations between the metric trends. The method may still further include determining one or more SEM patterns from two or more of the calculated operational metrics and metric trends.

A system for supporting problem resolution of an organization, in one aspect, may include a time series analyzer operable to identify a plurality of single-metric trends based on calculated operating metrics over a time span. A pattern detector may be operable to detect one or more SEM patterns over the time span based on one or more combinations of the plurality of single-metric trends. A graphical user interface module may be operable to present the SEM patterns and associated one or more actions.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates a method for supporting the management of a given enterprise in one embodiment of the present disclosure.

FIG. 2 is a diagram illustrating automatic pattern detection system architecture in one embodiment of the present disclosure.

FIGS. 3A and 3B show examples of confidence intervals in closure metrics in one embodiment of the present disclosure.

FIG. 4A shows an example of statistically and visually stable trend in a closure metric graph in one embodiment of the present disclosure.

FIG. 4B shows an example of metric trend that is visually unstable but statistically stable in one embodiment of the present disclosure.

FIG. 4C shows an example of period-to-period metric deterioration in one embodiment of the present disclosure.

FIG. 4D shows an example of gradual metric deterioration in one embodiment of the present disclosure.

FIG. 4E shows an example of period-to-period metric improvement in one embodiment of the present disclosure.

FIG. 4F shows an example of gradual metric improvement in one embodiment of the present disclosure.

FIGS. 5A-5D show an example of four metrics considered for detecting patterns of deterioration in major process metrics in one embodiment of the present disclosure.

FIGS. 6A-6D show an example of four metrics used to detect mixed behavior in process metrics that indicates deterioration in process efficiency in one embodiment of the present disclosure.

FIGS. 7A-7B show an example of a combination of the metrics of the present disclosure used to detect a pattern for a new product in one embodiment of the present disclosure.

FIGS. 8A-8D show an example of a combination of metrics used for detecting mixed behavior in process metrics that indicate improvement in process efficiency in one embodiment of the present disclosure.

FIGS. 9A-9C show an example of a combination of metrics used to observe improvement in all key process metrics in one embodiment of the present disclosure.

FIG. 10 illustrates an example of a user interface and output in one embodiment of the present disclosure.

FIGS. 11A-11B show an example SEM dashboard 1102.

FIG. 12 illustrates a schematic of an example computer or processing system that may implement the SEM pattern identification system in one embodiment of the present disclosure.

FIG. 13 illustrates an example graphical representation via which a user may enter a time span parameter specifying time period for performing SEM pattern analysis.

### DETAILED DESCRIPTION

Sustaining engineering and maintenance (SEM) using patterns and dashboards is disclosed in one embodiment of the present disclosure. A dashboard in the present disclosure, also referred to as “SEMinal” dashboard provides actionable insight into the efficiency of SEM organizations and processes. In one embodiment of the present disclosure, the dashboard measures trends of efficiency in SEM processes and helps organizations understand their current status, diagnoses common problems that can affect the organization's efficiency, determines the causes of those changes, and provides suggested actions based on industry best practices or on outcomes of handling prior incidences of these problems, and also assesses the efficacy of process or other changes that were instituted to improve the organization's performance. It provides this insight in one embodiment of the present disclosure via trends on five metrics displayed on four charts which, taken together, provide information about aspects of the organization's performance, and via the identification of a set of actionable patterns over one or more of the metric trends, which for instance help in differentiating different problems. These patterns are based on characteristics in the metric trends, and on relationships between the different metrics and trends. The patterns encapsulate diagnosis of common issues affecting the organization's efficiency, recommended actions to take to address them, and insight into other related patterns that may occur simultaneously or that may follow the ones detected.

In the present disclosure, an organization refers to an entity which accepts and processes requests. Operational data refers to a summary of the processing of the requests, including indication of when each request is received and when the associated processing is completed. Operational metrics refers to time-based calculated summaries of the operational data, e.g., the number of requests per month, or average handling time the requests closed per quarter. Remedial action refers to an action which eliminates a given negative pattern in the organization's future operational data.

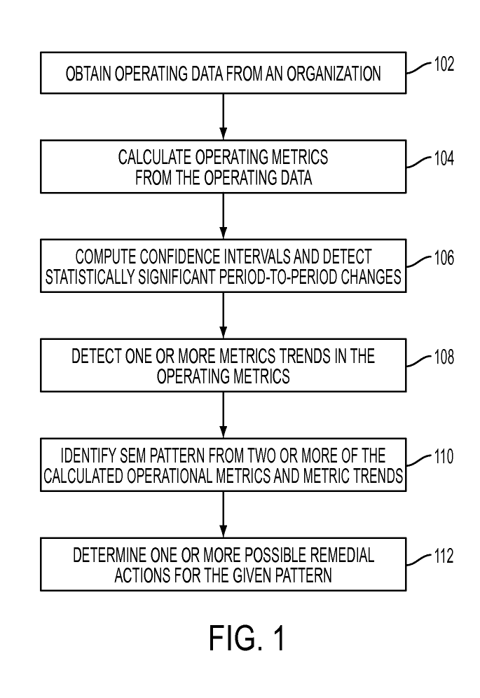

FIG. 1 illustrates a method for supporting the management of a given organization in one embodiment of the present disclosure. An example of the given organization may be an information technology (IT) entity. At 102, operating data is obtained from an organization. Operating data may be history of data associated with the organization and may include receipt and resolution time and dates of defects in the organization. For example, the operating data contains information about the defects including the date and time of when the defects are detected and resolved.

At 104, operating metrics may be calculated from the operating data. The calculated metrics may be displayed via a graphical user interface (GUI). The calculated metrics in one embodiment may include, but are not limited to, closure metric, open metric, closure count metric, arrival rate metric, and background metric.

At 106, statistically significant period-to-period changes and period-based confidence intervals may be computed for all or some operating metrics. The change markers and confidence intervals may be displayed via GUI.

At 108, one or more metrics trends are detected from the calculated operational metrics. Examples of trends may include, but are not limited to, steep deterioration, steep improvement, gradual deterioration, gradual improvement, seasonal, and stable. The direction of the calculated operational metrics over periods of time, statistically significant period-to-period changes and confidence intervals would indicate one or more of those trends. Specific rules may be defined for identifying those trends in the operational metrics. In one embodiment of the present disclosure, all of the available operating metrics may be used. In another embodiment of the present disclosure, criteria such as a range of dates or time period may be used to select the operating metrics. Thus, for instance, operating metrics for the month of January, or from January to March, or another range of time or dates may be used as criteria for selecting operating metrics from which one or more metrics trends may be detected. A user may be enabled to enter such criteria or range via a GUI.

At 110, an SEM pattern may be identified via relevant relation between metric trends, e.g., from two or more of the calculated operational metrics and metric trends. Pattern identification is based on decision rules that take into account metric values, metric trends and relations between different metric trends. One or more SEM patterns exhibited by the metrics may be determined. For example, definitions for pattern detection may be defined for automatically detecting the patterns based on the operational metrics and metric trends. Examples of SEM patterns include stable, steep efficiency deterioration, steep efficiency improvement, gradual efficiency deterioration (“creeping change”), gradual efficiency improvement, overload due to increase of arrival rate, overload due to decrease of productivity, managing to closure metric, closure metric deterioration due to possible focus on old defects, and seasonal. Other patterns may be also identified. In one embodiment of the present disclosure, one or more of the above patterns are determined or identified as a result of the operational metrics and metric trends satisfying the definition defined for the associated pattern.

Users may be enabled to enter or change criteria of pattern detection. The identified SEM patterns may be reported. In addition, the causes for the identified one or more SEM patterns may be provided. In one embodiment of the present disclosure, the identified one or more patterns may be indicated in the metrics displayed by the GUI.

At 112, one or more possible remedial actions for the given pattern may be determined and, for instance, suggested. The remedial actions may be also reported, for instance, along with the identified SEM patterns. The suggested remedial actions may be provided in a prioritized list of actions for each or selected identified SEM pattern. For instance, the remedial actions may be prioritized according to the severity of the identified SEM pattern.

The identifying of trends and patterns in FIG. 1 may utilize data computing techniques such as statistical analysis techniques that can identify patterns in data.

The SEM patterns may include patterns that are considered as being, but are not limited to, stable, seasonal, efficiency deterioration, efficiency improvement, closure metric deterioration due to possible focus on old defects, and overload. A given overload pattern instance can be further classified as to whether it is an overload due to increase of arrival rate or overload due to decrease in productivity. A given efficiency deterioration pattern instance can be further classified into gradual or steep efficiency deterioration patterns. A given efficiency improvement pattern instance can be further classified into gradual or steep efficiency improvement patterns.

A stable SEM pattern may occur when the defects are closed (e.g., addressed and resolved) at approximately the same rate over a period of time. In one embodiment of the present disclosure, closure, open, arrival and backlog metrics are checked for statistically significant changes for determining whether a pattern is stable. In another embodiment, a pattern may be diagnosed as being stable if the closure metric shows no statistically significant changes over a period of time. In yet another embodiment of the present disclosure, a backlog metric (measuring amount of backlog items) is always checked before diagnosing stable SEM pattern. Steep and prolonged increase in size of backlog may push older defects into the tail, giving incorrect appearance of Stable. If stable SEM pattern is detected, it may be checked to determine whether the closure rate is adequate. If so, stable SEM pattern signals good news. If not, changes in organization and/or process may be suggested to achieve the required rate. In addition, if stable SEM pattern is detected, checks may be made for: Multiple consecutive periods of statistically insignificant change in the same direction, which may suggest “Creeping Change”; Increasing Open Metric (usually staggered), which may signal that stability is being achieved via “Managing to the Metric”; Deteriorating relationship between Arrival Rate and Closure Count (with concomitant increase in backlog), which may presage “Overload.”

A creeping change SEM pattern indicates that the age of defects when they are closed is increasing or decreasing slowly but consistently over multiple periods of time or if the age of defects in the backlog is increasing or decreasing slowly but consistently over multiple periods of time. A creeping change SEM pattern instance may be diagnosed or detected if the closure metric or the open metric shows no period-to-period statistically significant changes, but there is a clear upward or downward trend over multiple periods. For a creeping change SEM pattern to occur, a statistically significant improvement or degradation between the first and last period exists. If a creeping change SEM pattern is detected, an improving or degrading Open Metric (often staggered) and Closure Metric in the same direction may be considered as the evidence for a true efficiency change. Only process or organizational changes should result in an improvement or degradation after stability. Team members or the like may determine cause and sustainability. If creeping change SEM pattern is detected, it is also check for: A degrading Open Metric and/or Closure Count Metric in the presence of an improving Closure Metric, which may indicate “Managing to the Metric.”

Overload SEM pattern may occur when a team or the like cannot close defects as fast as they are arriving for a period of time. An overload SEM pattern instance may be detected or diagnosed if relationship between arrival rate and closure count metrics is degrading over multiple periods of time or degraded without improving. Overload may occur, for instance, as a result of event-driven spike, characterized by spike in arrival rate metrics after period of relative stability. In this case, closure count and closure metrics remain stable. As another example, overload may occur as a result of reduced team capacity. In this scenario, arrival rate metrics remains relatively stable, but closure count metric shows degradation. Backlog size will always increase in the presence of overload. In less severe case of overload, open metric shows degradation (often staggered). In more severe cases, increasing backlog size may push older defects into the tail. It may or may not be necessary to respond to overload. If overload is detected, the cause is identified. For “Event-Driven Spike,” a clear causative event (e.g., a new product release) may be identified and whether the overload is likely to persist may be ascertained or determined. For “Reduced Team Capacity,” it may be determined whether cause is likely to resolve itself (e.g., new team members). A deteriorating closure metric may suggest as underlying causes reduced team size, change in team composition, or change in process with negative efficiency impact. If overload is diagnosed and further a “Reduced Team Capacity” detected, an improving closure metric may suggest “Managing to the Metric.” “Reduced Team Capacity” can occur in the presence of “Seasonal Spree.”

Managing to the metric SEM pattern may occur when teams give higher priority to newer defects over older ones. Managing to the metric SEM pattern is characterized by an improvement in closure metric and deterioration of open metric in the same time interval. There may be a stagger between improvement in closure metric and deterioration in open metric. Backlog metric helps determine severity of the problem. This pattern generally occurs as a way to improve a deteriorating closure metric. It is not a sustainable improvement, and it can lead to serious efficiency and customer satisfaction issues. The causes of efficiency degradation problems should be identified, and real solutions should be instituted. This pattern often occurs after a period of closure metric deterioration. An earlier negative creeping change or statistically significant negative changes may lead to the managing to the metric SEM pattern.

Seasonal spree SEM pattern may occur when defects are allowed to age for some period of time, then most are closed at the end of this time, and the pattern repeats. Seasonal spree has a characteristic pattern in closure metric of degradation (statistically significant or creeping change) for some period of time, followed by a large, statistically significant improvement. This repeats over similar time intervals. Open metric shows a similar pattern to closure metric over the same interval. A common form of seasonal spree is an end-of-year closing out of defects.

Stable-change-stable pattern often reflects a change in an organization and/or process that caused a prolonged impact on efficiency. Prior to the change, the organization was stable at one rate, and afterwards, it became stable at (usually) a different rate. This pattern may be diagnosed by a sequence of three patterns in succession: Stable, followed by either statistically significant change or creeping change, followed by stable (typically at a higher or lower rate). The “Change” period may show some instability, and even other patterns, before the new stable pattern occurs. This does not disqualify a Stable-Change-Stable diagnosis. To identify the cause of the change, recent events may be analyzed. If stability resumes at a similar closure metric value as originally, this may reflect a temporary change in the organization (e.g., temporary reassignment of personnel). If the change was a one-period statistically significant change, it need not reflect any change in the organization or process.

The determination of the SEM patterns may also include ranking the identified patterns according to their severity (e.g., of three identified SEM patterns, indicating that the first identified pattern #1 may cause the organization to fail completely, while the remaining 2 patterns are only of mild concern, only needing to be monitored in the future).

In one embodiment of the present disclosure, the method steps shown in FIG. 1 may be offered by a service entity (e.g., referred to as a first user) to a customer organization (e.g., referred to as a second user). The extent of the list of SEM patterns provided by the first user to the second may be determined by a service contract between the first and second users. For example, the service entity may provide more or less, or particular patterns depending of the service contract with the customer organization. In addition, the service entity can offer to search for new additional SEM Patterns for the customer organization.

In one aspect, the identified SEM patterns may be used as the basis for an SLA (Service Level Agreement), e.g., an SLA which specifies the SEM pattern #1 will never occur. The resolution of an identified SEM pattern(s) may be also used as the basis for an SLA (Service Level Agreement), e.g., an SLA which specifies that any identified SEM pattern #1 will be resolved within 1 week.

Patterns generally involve trends over, and relationships between, multiple metrics. In one embodiment of the present disclosure, SEMinal dashboards are presented, which for example, facilitate determining different SEM patterns, based on trends over, and relationships between, some or all of the metrics. These patterns help a user understand the current status of a product or organization, diagnose problems that are impeding the efficiency of an organization in supporting products, and assess the efficacy of remediation that may be put into place to address problems or improve the organization's efficiency. Diagnostic process for identifying relevant patterns is disclosed below. SEMinal dashboard may contain multiple relevant patterns. For example, in a two-year period in the service history of a product, there may be a period during which the organization exhibited the stable pattern (Section 2.3), followed by a period of active degradation (Section 2.4). A user via the SEMinal dashboard may identify each pattern by following the procedure described below each time period of interest. The identified pattern may be used to help the trained person interpret the data and identify and diagnose issues more quickly.

### Closure Metric

Closure metric indicates the xth percentile of age of closed defects in a given time period. The default value of x is 80% but this parameter can be configured by a user. In one embodiment of the present disclosure, dashboard interpretation may start with the closure metric graph. The dashboard, for instance, may show the closure metric graph on the upper left side. In one embodiment of the present disclosure, the closure metric shows the trend of the 80-percentile value for each time period. The 80-percentile value for a given time period is the number of days that it took to close 80% of the reported defects that were closed during that period. For example, if a given time period has an 80-percentile value of 50 days, 80% of the defects were closed during that time period, each of them was closed in 50 days or fewer. Each of the other 20% of the defects that were closed took longer to close.

In one embodiment of the present disclosure, the closure metric graph also shows vertical green bars on each time period reported. These represent the confidence intervals for the metric. The confidence intervals may be computed via non-parametric statistical techniques in one embodiment of the present disclosure. Non parametric statistical techniques refer to methods that do not assume a specific form (e.g., normal, exponential) of age distribution. The confidence intervals may be used for the following purposes. They may be used as a visual filter for “noise” in the closure metric graph. If the confidence intervals for two periods do not overlap, it may be inferred that a statistically significant change in the closure metric has occurred between those two periods. If the confidence intervals for two periods largely overlap each other, then no statistically significant change in the metric has occurred between those two periods.

The size of the confidence intervals may be used to help a user understand the reliability of the closure metric for each time period. In general, the closure metric will be more reliable if there are a larger number of defects were closed during a given time period (i.e., a larger sample size) and less reliable if a smaller number of defects was closed. Usually, larger confidence intervals reflect smaller sample sizes. They reflect lower reliability of the closure metric for that time period.

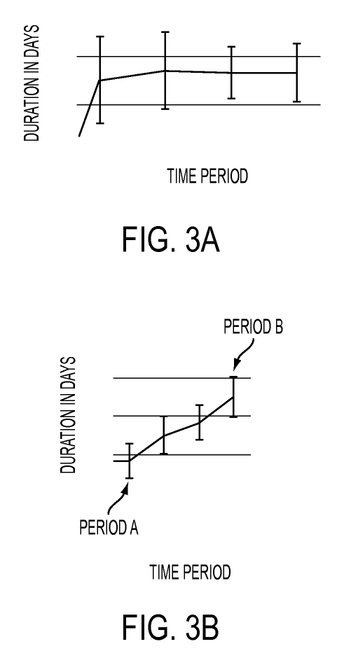

For example, in FIG. 3A, all of the confidence intervals in the closure metric overlap one another significantly. On the other hand, in FIG. 3B, Period A has a confidence interval that does not overlap at all with the confidence interval for Period B. The top of period A's confidence interval bar is lower than the bottom of period B's. They do not overlap. If all of the confidence intervals in the closure metric graph overlap significantly, e.g., as in FIG. 3A, the closure metric is characterized as stable in one embodiment of the present disclosure. In this case, further analysis of other metrics may be performed to determine whether the organization is exhibiting a stable pattern. If two or more periods in the graph do not have overlapping confidence intervals, as in FIG. 3B, there may exist an active slow improvement or active slow deterioration pattern. If the later non-overlapping period (like Period B in FIG. 3B) has a confidence interval that is above the confidence interval of the earlier period, deterioration in the metric may have occurred. If the later non-overlapping period has a confidence interval below that of the earlier period, improvement in the metric may have occurred.

In one embodiment of the present disclosure, closure metric may be provided that contains dots. The presence of a black or grey dot in the closure metric graph indicates that a statistically significant period-to-period change has occurred. If a black dot is presented at a time period in the graph, it means that from the previous time period to the one with the black dot, the organization exhibited a statistically significant negative change in the closure metric. A grey dot means that the organization exhibited a statistically significant positive change in the closure metric.

A statistically significant negative change means that the defects closed during the period with the black dot were significantly older than the defects that were closed during the previous period. In general, there are two reasons why this happens. Statistically significant negative changes in the closure metric can occur if it is taking the organization longer to close defects than it did previously. This may be due to such issues as reduction of the size of the service team; an unexpected inflow of unusually difficult defects; process or other changes that are interfering with the team's efficiency (e.g., new reporting requirements that consume significant amounts of the team's time and leave them with less time to close defects); and many other reasons. A statistically significant negative change in the closure metric can be flagged if the organization closed a number of older defects during a time period. In this case, the negative change in the metric need not reflect any problem in the organization, and if there are no other signs of problems, a user may ignore it.

A single period of statistically significant negative change may represent a one-time issue that requires no action, or it may signal a deeper problem that requires attention. Multiple consecutive periods of statistically significant negative changes may reflect a more substantial problem. To determine the root cause of any statistically significant negative changes in the closure metric, a user may consult the organization's service team. Some of the patterns can help a user understand possible root causes.

A statistically significant positive change means that the defects closed during the period with the grey dot were significantly younger than the defects that were closed during the previous period. There may be two common causes of statistically significant positive changes. First, statistically significant positive changes in the closure metric can occur if the organization is closing defects more quickly than it did previously. This may be due to a number of reasons, such as an increase in the size of the service team; an inflow of easy-to-close defects; process or other changes that have improved the team's ability to service the defects more efficiently; etc. Second, a statistically significant positive change in the closure metric can occur if the organization closed a number of newer defects during a period. In this case, the positive change may not reflect any sustainable efficiency improvement in the organization. Indeed, if the team closes only newer defects indefinitely, their backlog will eventually age.

A single period of statistically significant positive change may represent a one-time occurrence, or it may reflect a real organizational improvement. Multiple periods of statistically significant positive changes may reflect a real, sustainable improvement. To determine the root cause of any statistically significant improvement in the closure metric and whether it reflects a sustainable change in the organization, a user may consult the service team. The patterns can help a user to differentiate sustainable improvement from other causes of positive changes in the closure metric that do not reflect an improvement in organizational efficiency.

### Arrival Rate, Closure Count Metric, Open Metric, and Backlog Graphs

SEMinal dashboard of the present disclosure in one embodiment also provides several other metrics, which may be analyzed, for instance, in relation to the analysis performed on a closure metric graph, to identify patterns.

The arrival rate and closure count metric may be shown together in the upper right graph of the SEMinal dashboard. The arrival rate indicates the total number of defects that were opened during each time period. The closure count metric indicates the total number of defects that were closed during each time period. When characterizing the arrival rate and closure count metric graphs, one may look at the following:
Closure Count Metric stability: Is the team closing similar numbers of defects each time period? If so, a user can characterize the closure count metric as stable. If not, characterize it as increasing if the count is generally trending upwards over time; decreasing if it is generally trending downward over time; and unstable if it is oscillating up and down, with no distinct increasing or decreasing trend.
Relationship between Arrival Rate and Closure Count Metric: If the arrival rate is generally larger than the closure count metric over time, characterize the relationship between arrival rate and closure count as deteriorating. If the arrival rate is generally less than the closure count metric over time, characterize the relationship as improving. If the arrival rate is equal to the closure count metric over time, characterize the relationship as stable.

In general, if the team is closing defects as fast as they are arriving (or faster), this is a good sign. If the team cannot close defects as fast as they are arriving for extended periods of time, this will ultimately lead to an unmanageable backlog of defects.

The arrival rate may change significantly from period to period. An increase in arrival rate is not, by itself, problematic, unless it lasts for a prolonged period of time. It is also not problematic if the team's closure count metric is below the arrival rate for some period of time, as long as this situation does not continue for so long that it endangers the organization's ability to meet its SLA commitments.

Open metric, which for instance may be displayed in the lower left side of the SEMinal dashboard, shows trends in the age of the team's backlog of open defects. Like the closure metric, in one embodiment of the present disclosure, the open metric is an 80-percentile value (80% is a default that can be configured by user): it shows the age (in number of days) of 80% of the defects that were still open at the end of each time period. For example, if a given time period has an open metric value of 100 days, 80% of the defects that were still open at the end of that time period was open for 100 days or less. Each of the other 20% of the defects that were open was older than 100 days.

Like the closure metric, the open metric graph in one embodiment of the present disclosure contains confidence intervals that may be used as a visual filter for statistically insignificant “noise” in the graph, and to understand the reliability of the metric. Open metric graph may be characterized in the same way as the closure metric graph. Period-to-period statistically significant positive and negative changes are highlighted with grey and black dots, respectively. Slower improvement and degradation trends over multiple time periods, as well as stability in the metric, may be also identified in the same way.

The Backlog in one embodiment of the present disclosure may be shown in the lower right graph of the SEMinal dashboard. The Backlog indicates the total number of defects that were still open at the end of each time period. To evaluate the stability of the backlog graph, determine whether the number of open defects is staying approximately the same over time, with no overall increase or decrease in the size of the backlog. If so, the backlog graph is stable. If there is an overall increase in the size of the backlog over time, characterize the backlog graph as deteriorating. If there is an overall decrease in the size of the backlog over time, the graph is improving.

If all of the confidence intervals overlap significantly in the closure metric graph, the data may reflect the stable pattern. The stable pattern generally indicates that the organization has closed approximately the same number of defects (Closure Count Metric) at approximately the same rate (Closure Metric) throughout the period of time under examination. If the closure metric is acceptable, the stable pattern is good news, as it suggests that the team is operating sustainably at the efficiency required. If the closure rate is too low, e.g., the closure count remains low for a period of time, the stable pattern may suggest the need for changes in the size of the team or the process they use, as the team is likely doing the best it can under the current circumstances.

To confirm the presence of the stable pattern, the closure count metric, open metric, and backlog graphs may be analyzed. If all of those graphs exhibit stability, the data indicates the stable pattern. If any of them are unstable, the table below (Table 1) may be used for possible interpretations.

TABLE 1

| If there is no | |
|---|---|
| stability in the . . . | . . . then there may be these patterns |
| Closure Count | If the Closure Count Metric decreased, proceed to |
| Metric | determine further whether the team is fielding |
| | fewer defects and taking the same amount of time |
| | per defect, or there are fewer defects coming in, or |
| | there is team size reduction. If the Closure Count |
| | Metric increased, proceed to evaluate a possible |
| | pattern such as whether the team is fielding more |
| | defects at the same rate, large rate, there is a |
| | larger team size or the team is working overtime, |
| | which may be not sustainable. |
| Open Metric | Instability of the Open Metric when the Closure |
| | Metric is stable generally should occur only if the |
| | Arrival Rate or Closure Count Metric has |
| | changed. In this case, follow the diagnostic |
| | instructions above for Closure Count Metric or |
| | Arrival Rate. In this case, follow the diagnostic |
| | instructions on pages 16-17 for Closure Count |
| | Metric or Arrival Rate. |
| Backlog | If the Closure Metric is stable, the Backlog will |
| | generally increase or decrease when the Arrival |
| | Rate increases or decreases without a correspond- |
| | ing increase or decrease in Closure Count Metric. |
| | In this case, follow the diagnostic instructions |
| | above for Arrival Rate and Closure Count Metric. |

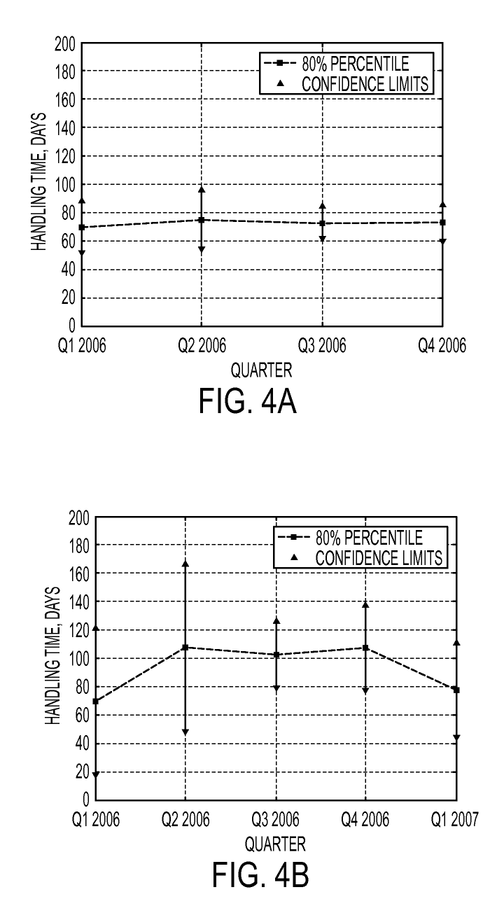

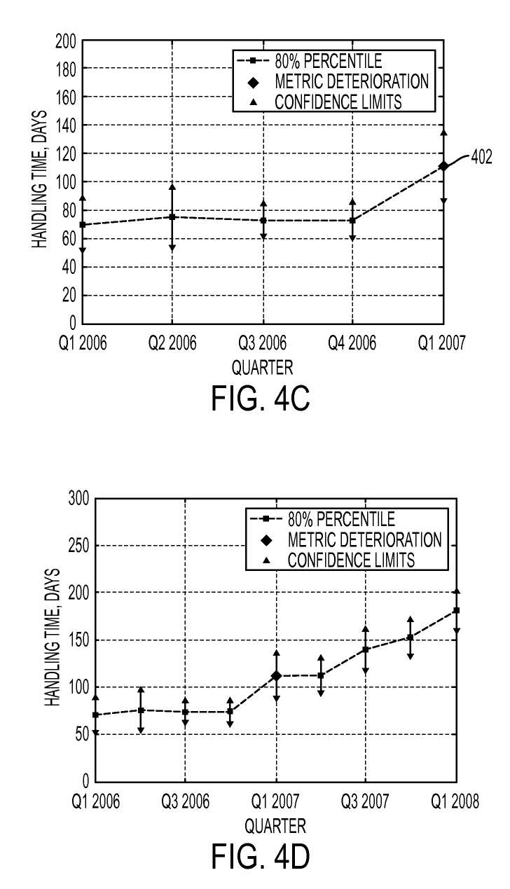

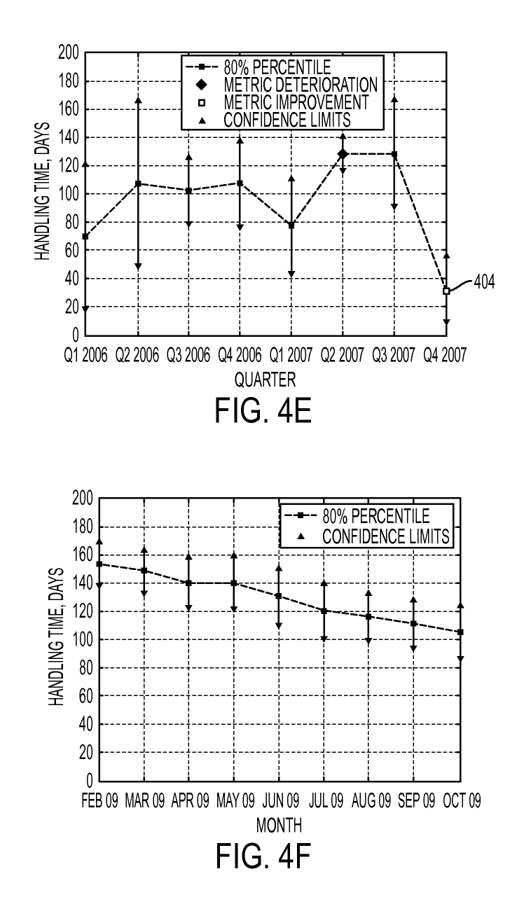

FIG. 4A shows an example of statistically and visually stable pattern in a closure metric graph. The graph shows closure metric, which shows 80% percentile for handling time of closed defects. The metric pattern is both visually and statistically stable. The metric is in control.

FIG. 4B shows an example of metric pattern that is visually unstable but statistically stable. The graph shows closure metric, which shows 80% percentile for handling time of closed defects. There are visually significant changes in the closure metric. However, these changes are not statistically significant (note large confidence intervals) and can be attributed to “random noise”.

Recommendations for stable metric pattern may be that if the average metric level is satisfactory, no action is needed concerning this metric. However, other metrics should be considered in order to come to conclusion that SEM process is managed efficiently.

FIG. 4C shows an example of period-to-period metric deterioration. The graph shows closure metric, which shows 80% percentile for handling time of closed defects. Statistically significant deterioration is observed between Q4 2006 and Q1 2007. This deterioration is marked by the red point 402 on the graph. If a metric deterioration is detected, a stakeholder should explore its reasons, checking other metrics, and if needed, exploring the defect data deeply. The deterioration can indicate general deterioration in process efficiency, but sometimes deterioration in the closure metrics indicates that efforts are invested in decreasing the number of long-term defects. There is also a small probability that single-point deterioration is related to “random noise” (roughly, 2.5% probability for 95% confidence level and 0.5% probability for 99% confidence level).

FIG. 4D shows an example of gradual metric deterioration. The graph shows closure metric, which shows 80% percentile for handling time of closed defects. Metric deterioration between Q1 2007 and Q1 2008 is gradual and no period-to-period statistically significant change is detected. However, note that Q1 2008 confidence interval is above Q1 2007 confidence interval. It means that there is a statistically significant change between Q1 2007 and Q1 2008. Gradual metric deterioration over a long period is even more worrisome than single-period deterioration and usually indicates problems with SEM process efficiency. A stakeholder should examine the SEM process in detail.

FIG. 4E shows an example of period-to-period metric improvement. The graph shows closure metric, which shows 80% percentile for handling time of closed defects. Statistically significant improvement is observed between Q3 2007 and Q4 2007. This improvement is marked by the green point 404 on the graph. In general, a statistically significant metric improvement is a positive development. However, a stakeholder should consider all relevant metrics in order to come to conclusion on improvement of SEM process efficiency.

FIG. 4F shows an example of gradual metric improvement. The graph shows closure metric, which shows 80% percentile for handling time of closed defects. Metric improvement between February 2009 and October 2009 is gradual and no period-to-period statistically significant change is detected. However, note that August-October 2009 confidence intervals are below February 2009 confidence interval. It means that there is a statistically significant change between the corresponding periods. Gradual metric improvement over a long period usually indicates improvement of SEM efficiency. However, other metrics should be also monitored.

In order to come to conclusion on deterioration or improvement of SEM process efficiency, several metrics should be jointly considered. In one embodiment of the present disclosure, closure metric, open metric and backlog may be selected as key performance metrics. Additional two metrics, arrival rate and closure count metric, are also helpful for understanding different phenomena in SEM process.

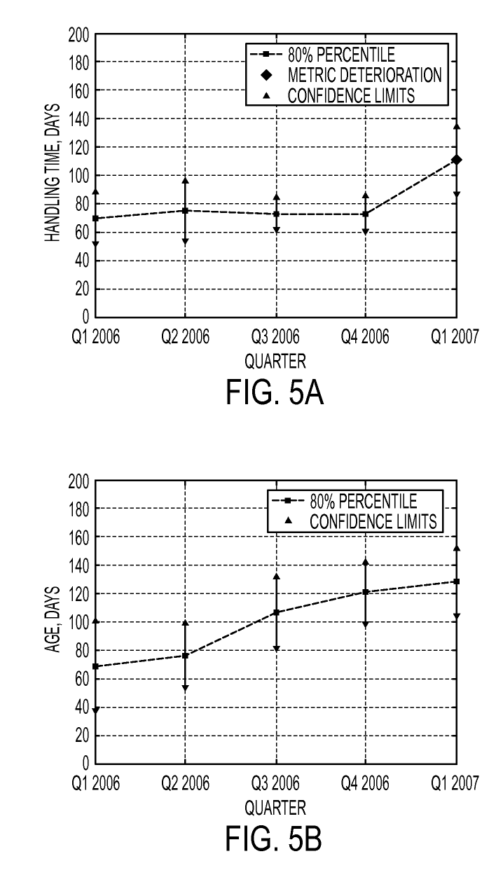

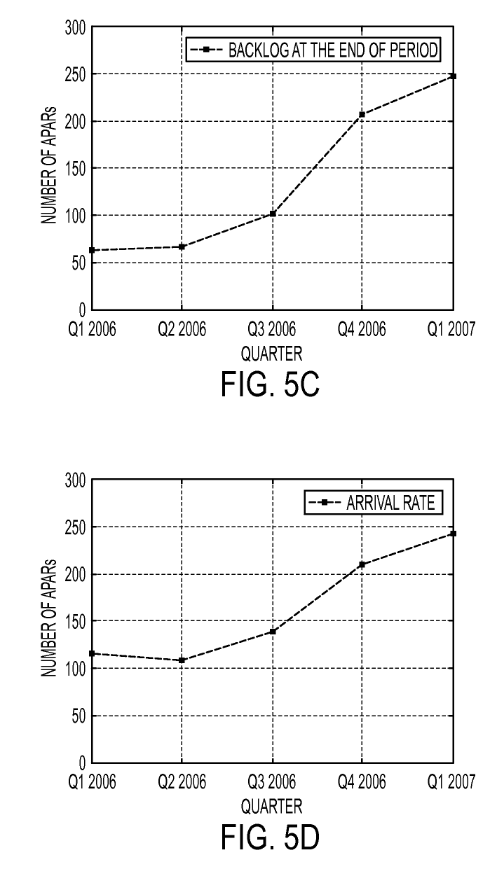

FIGS. 5A-5D show an example of four metrics considered for detecting patterns of deterioration in major process metrics. FIG. 5A illustrates closure metric showing 80% (percentile) for handling time of closed defects. FIG. 5B is an open metric graph showing 80% (percentile) for age of open defects at the end of period. FIG. 5C is a backlog graph showing the number of open defects at the end of period. FIG. 5D illustrates an arrival rate metric. In this example, deterioration pattern may be observed in several key metrics and, hence, deterioration in the efficiency of SEM process. The closure metric (FIG. 5A) deteriorates in Q1 2007. A gradual increase of the open metric (FIG. 5B) is observed over all period. The backlog steadily increases in FIG. 5C. In FIG. 5D, the increase of the arrival rate over the considered period may explain (thus identify one of the causes of) the SEM process deterioration. Correcting measures should be taken. For example, if the increase of the arrival rate is the main reason of deterioration, more resources should be added.

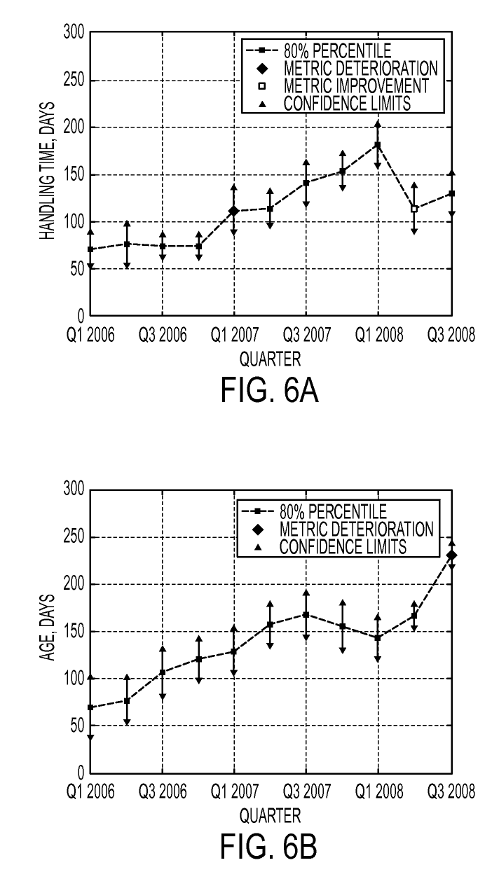

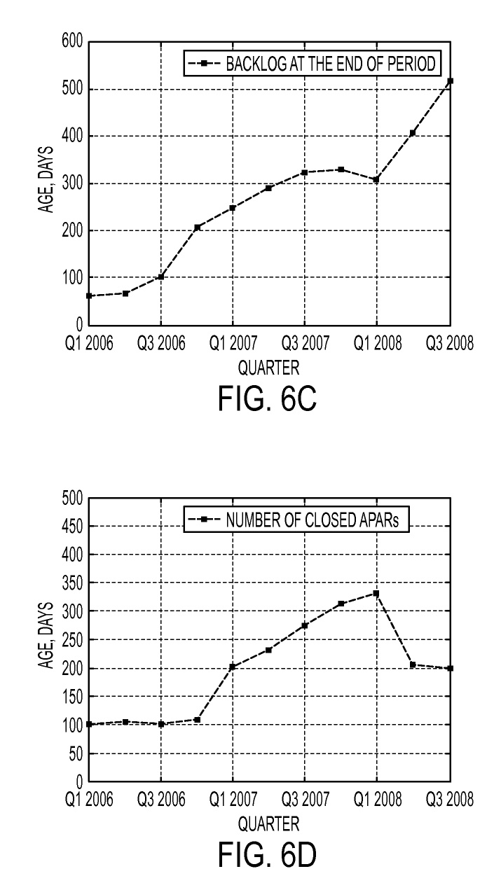

In one embodiment of the present disclosure, the four metrics may be used to detect mixed behavior in process metrics that indicates deterioration in process efficiency. As an example, consider the four metrics shown in FIGS. 6A-6D focusing on the second and the third quarters of 2008. FIG. 6A illustrates closure metric showing 80% (percentile) for handling time of close defects. FIG. 6B is an open metric graph showing 80% (percentile) for age of open defects at the end of period. FIG. 6C is a backlog graph showing the number of open defects at the end of period. FIG. 6D illustrates closure count metric in which the graph shows the number of closed defects per period. In this example, significant improvement of the closure metric (FIG. 6A) in Q2-Q3 2008 is observed. However, the open metric deteriorates (FIG. 6B) and the backlog (FIG. 6C) steadily increases. The decrease in the closure count metric (FIG. 6D) is also suspicious;, it seems that a relatively small number of short-term defects is closed. Summarizing, deterioration of SEM process efficiency continued in Q2-Q3 2008. As recommendation, correcting measures should be taken. In this specific case, these measures should include reconsidering defect priority policy: more effort should be invested in the long-term defects.

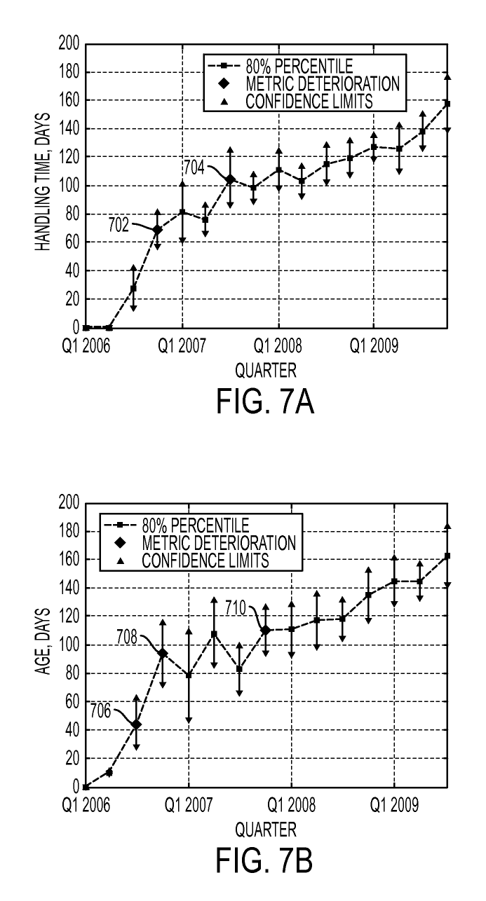

In another embodiment, a combination of the metrics of the present disclosure may be used to detect a pattern for a new product. For instance, if a new product is released to the market, the key metrics increase from zero. Consider, for example, closure and the open metrics shown in FIGS. 7A-7B. FIG. 7A illustrates closure metric showing 80% (percentile) for handling time of close defects. FIG. 7B is an open metric graph showing 80% (percentile) for age of open defects at the end of period. In this example, deterioration in both metrics is observed: there are several red points (702, 704, 706, 708, 710) and a general increase pattern. This deterioration after product release may be “natural” to some extent. However, in this example, deterioration continues for three years, which may be indicating problems in SEM process efficiency. A recommendation may be provided that while metrics increase after product release is “natural”, if the values of metrics exceed Service Level Agreements or metrics continue to deteriorate for a long time, a stakeholder should examine the SEM process.

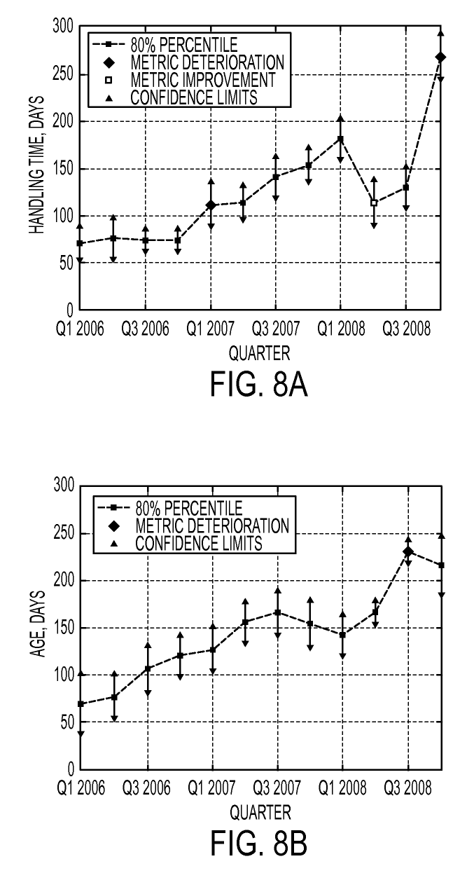

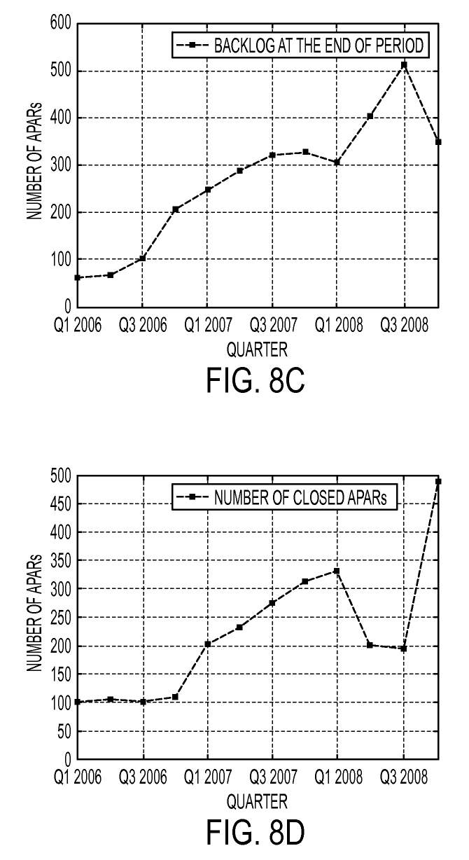

Yet in another embodiment, a combination of the metrics of the present disclosure may be used to detect improvement in SEM process efficiency. For instance, mixed behavior in process metrics may be detected that indicate improvement in process efficiency. As an example, consider the metrics shown in FIGS. 8A-8D, focusing on the fourth quarter of 2008. FIG. 8A illustrates closure metric showing 80% (percentile) for handling time of close defects. FIG. 8B is an open metric graph showing 80% (percentile) for age of open defects at the end of period. FIG. 8C is a backlog graph showing the number of open defects at the end of period. FIG. 8D shows closure count metric with the number of closed defects per period. In this example, a significant deterioration of the closure metric (FIG. 8A) is observed in Q4 2008. The open metric (FIG. 8B) remains stable. However, the backlog (FIG. 8C) decreased and an unusually large number of defects was closed during the quarter. It seems that SEM process efficiency improved. However, one should wait for the next period or perform a deeper analysis in order to come to firm conclusions. A recommendation may be provided that if the closure metric deteriorates but other metrics improve, a stakeholder should be “cautiously optimistic”. However, the stakeholder should continue to monitor the process: if SEM process efficiency really improved, the closure metric should improve during the next periods.

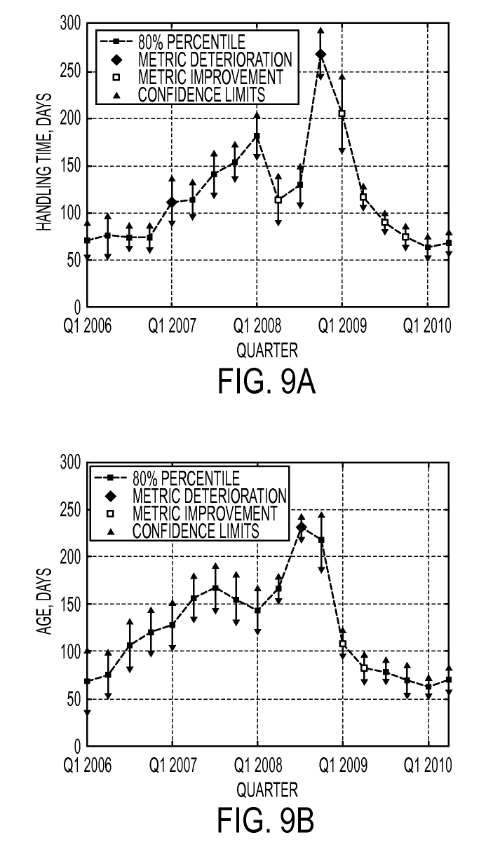

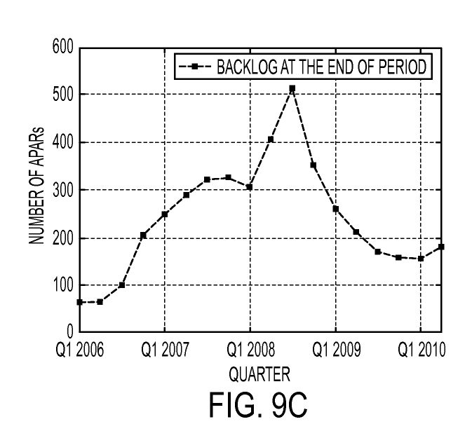

Improvement in all key process metrics may be observed, for instance, by considering a combination of metrics. For example, consider the three metrics shown in FIGS. 9A-9C, focusing on 2009 and 2010. FIG. 9A illustrates closure metric showing 80% (percentile) for handling time of close defects. FIG. 9B is an open metric graph showing 80% (percentile) for age of open defects at the end of period. FIG. 9C is a backlog graph showing the number of open defects at the end of period. Starting from Q1 2009 improvement in the key metrics is observed. Process managers succeeded to improve process efficiency and bring it under control. A recommendation may be provided indicating that process is under control, no action is needed, and to continue monitoring the processes.

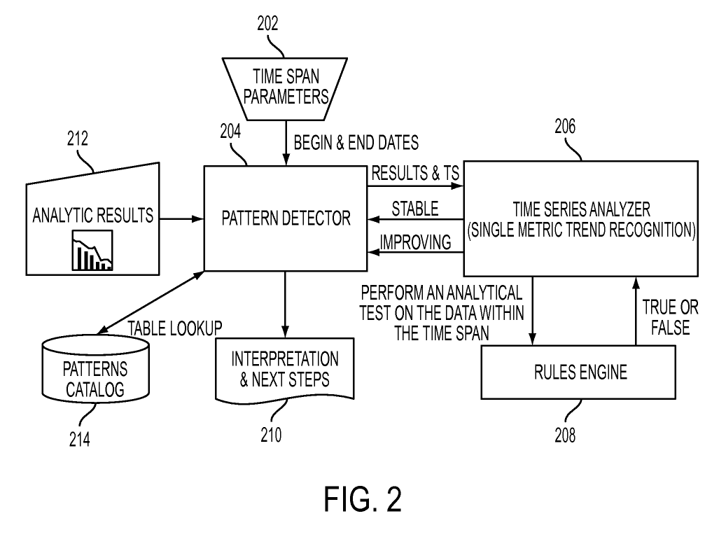

FIG. 2 is a diagram illustrating automatic pattern detection system architecture in one embodiment of the present disclosure. Time span parameters 202 specify the period, e.g., begin and end dates, within which to detect the SEM patterns. The parameters 202 may be input by a user via a GUI in one embodiment of the present disclosure. For example, if a user is interested in detecting patterns in 2010 and 2011, the user should input January 2010 as the start period, and December 2011 as the end period.

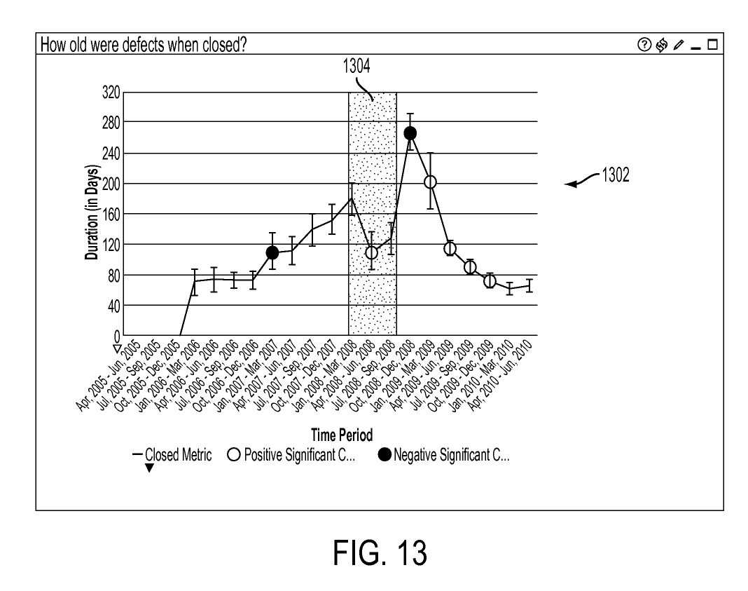

As another example, a user may be presented with a graphical representation of one or more timelines or graphs spanning the complete data set (e.g., shown in FIG. 13) and the user may gesture (e.g., with a mouse or other pointing device) to select the begin and end dates. In one embodiment of the present disclosure, the graphical representation 1302 may highlight the selected date range on each timeline or graph, for example, by displaying a box or highlighted area 1304 over the timeline or graph covering the date range selected. The user may select a different date range by gesturing (e.g., with a mouse or other pointing device) on any of the timelines or graphs displayed and the new date range may be highlighted. Once a date range is selected, the date range may automatically be sent as input to 202 or the user may indicate (e.g., by pressing a button) that the current date range be sent as input.

A pattern detector 204 may be a computing component such as a special processor or a module that executes on a processor. The pattern detector 204 identifies SEM patterns, for instance, from the single metric trends recognized by a time series analyzer 206. In one embodiment of the present disclosure, the pattern detector 204 transfers to time series analyzer 206 analytic results 212 and time span parameters 202. Time series analyzer 206 returns single metric trends (e.g., stable, improving, deteriorating, seasonal) and time periods within time span parameters 202. The pattern detector 204 uses these single metric trends and decision rules in patterns catalogue 214 to detect patterns and corresponding time period within time span parameters 202. Interpretations and next steps 210, based on the detected patterns, are provided to user.

A time series analyzer 206 may also be a computing component such as a special processor or a module that executes on a processor. The time series analyzer 206 detects trends in each of the metrics, for instance, individually. For example, single metric trend may be recognized in each of closure metric, open metric, backlog metric, closure count metric, arrival rate metric. Other metric trends may be detected. The time series analyzer 206 receives analytics results 212 and time span parameters 202 from the pattern detector 204. The time series analyzer 206 may utilize a rules engine 208 in identifying the trends. The time series analyzer 206 communicates the single metric trends to the pattern detector 204.

In one embodiment of the present disclosure, the time series analyzer 206 may employ a rules engine 208, for instance, which receives analytic results 212 for a specific metric and time span parameters 202 from time series analyzer 206. Rules engine 208 may perform analytical tests and decision rules on the data of this metric within the specified time span, for instance, as directed by the time span parameters 202. The rules engine 208 may transfer trends for a specific metric and corresponding time periods to time series analyzer 206.

For example, the rules engine 208 may use the following rules shown in Table 2 to detect single-metric trends. The rules engine 208 may analyze the operating data of an organization and determine whether the data meets the criteria specified in the “definition” column of the table. If so, the associated trend specified in the “name” column of the table, is deemed to be detected. It is noted that the definitions may change.

TABLE 2

| Name | Code | Definition |
|---|---|---|
| Steep | 1 | Trend length (how many periods trend contains) |
| deterioration | | L ≧ 2. |
| | | Trend detection: black point at interval i. In |
| | | addition, the confidence interval at interval i is |
| | | above the confidence interval at interval i-2. |
| | | Trend continuation: only black points are |
| | | observed. |
| Steep | 2 | Similar to 1. |
| improvement | | |
| Gradual | 3 | Trend length L ≧ 4. |
| deterioration | | Trend detection: a confidence intervals is above |
| | | a confidence intervals in the past. Monotone |
| | | increase of the metric is observed between the |
| | | two confidence intervals. No other deterioration |
| | | trends in the detection period (except the first |
| | | point that can finish some other trend); no grey |
| | | or black points in the detection period (except |
| | | probably the first one). |
| Gradual | 4 | Similar to 3. |
| improvement | | |
| Seasonal | 5 | Trend length L = 8. |
| (definition | | Trend detection: the same order relation for |
| for three-month | | metric values in four quarters of two consecu- |
| resolution) | | tive years is observed (approximately consistent |
| | | with 5% confidence level). At least one statisti- |
| | | cally significant change is observed during each |
| | | year. |
| | | If a strict decrease or a strict increase of the |
| | | metric is observed during two years in considera- |
| | | tion, a seasonal trend is not detected. |
| | | Remark. Compatible with improvement/deterio- |
| | | ration trends. |
| Stable | 6 | Trend length L ≧ 4. |
| | | Trend detection: all confidence intervals inter- |
| | | sect during four periods. No black or grey points |
| | | (except probably the first one). No intersection |
| | | with deterioration or improvement periods (except |
| | | the border points). |
| | | Trend continuation: confidence intervals continue |
| | | to intersect with all previous intervals. No grey |
| | | or black points. |

Note that a single black/grey point (period-to-period metric deterioration/improvement computed in module 212) does not necessarily imply steep deterioration/improvement trend.

In one embodiment of the present disclosure, analytic results module 212 calculates organizational metrics from customer data, computes confidence intervals for the metrics and detects statistically significant period-to period deterioration/improvement for these metrics. The periods, where statistically significant period-to period deterioration/improvement takes place, can be marked by black/grey point (or by any other notation) in GUI. In one embodiment of the present disclosure, computation of confidence interval and period-to-period changes for percentile-based open and closure metrics may be based on non-parametric statistical tests. U.S. patent application Ser. No. ______ (Attorney Docket IL9-2011-0004US1) filed on Aug. 9, 2011, entitled “Analyzing a Process of Software Defects Handling Using Percentile-Based Metrics” describes examples of those methods. That application is incorporated herein by reference in its entirety. Confidence interval for metrics may be also based on Poisson approximations. Metric values, confidence intervals and period-to-period change indicators are transferred to pattern detector 204 and time series analyzer 206.

In one embodiment of the present disclosure, pattern catalog 214 receives single metric trends and the corresponding time periods from pattern detector 204 and applies decision rules of the pattern catalogue in order to detect efficiency patterns.

Table 3 shows an example of partial pattern catalogue. The patterns specified in the example may be detected based on the criteria specified in the definition in which the criteria are met by a combination of specified single-metric trends.

TABLE 3

| Name | Code | Pattern Detection Definition (rough) |
|---|---|---|
| Stable | 1 | Closure, opened, backlog, arrival metrics are |
| | | stable. |
| Steep | 2 | Consider two percentile metrics and backlog |
| efficiency | | size (further referred to as efficiency metrics). |
| deterioration | | One of the following occur: |
| | | Two efficiency metrics deteriorate and at least |
| | | one of them deteriorates steeply. |
| | | One of percentiles metrics deteriorates steeply |
| | | and no metrics improve. |
| Steep | 3 | One of percentiles metrics improves steeply |
| efficiency | | and no efficiency metrics deteriorate. |
| improvement | | |
| Gradual | 4 | One of the following occur: |
| efficiency | | Two efficiency metrics deteriorate gradually. |
| deterioration | | One of percentile metric deteriorates |
| (“creeping | | gradually and no efficiency metrics improve. |
| change”) | | |
| Gradual | 5 | One of percentiles metrics improves gradually |
| efficiency | | and no efficiency metrics deteriorate. |
| improvement | | |
| Overload due | 6 | Deterioration pattern 2 or 4 combined with |
| to increase of | | deterioration trend (steep or gradual) of |
| arrival rate | | arrival rate. |
| Overload due | 7 | Deterioration pattern 2 or 4 combined with |
| to decrease of | | deterioration trend (steep or gradual) of |
| productivity | | backlog and non-deteriorating arrival rate. |
| Managing to | 8 | Closure metric improves, open metrics deteri- |
| closure metric | | orates, backlog does not improve OR Closure |
| | | metric improves, backlog deteriorates, open |
| | | metric does not improve. |
| Closure metric | 9 | Closure metric deteriorates, open metric |
| deterioration | | improves, backlog does not deteriorate OR |
| due to possible | | Closure metric deteriorates, backlog improves, |
| focus on old | | open metric does not deteriorate. |
| defects | | |
| Seasonal | 10 | Seasonal pattern detected for any metric. |

In one embodiment of the present disclosure, interpretation and next steps module 210 receives detected patterns and corresponding time intervals from the pattern detector 204. It provides information on pattern to a user. For example, the description of Gradual Deterioration pattern is: “At least one important efficiency metric deteriorates slowly but consistently over multiple periods of time”. The recommended actions for this pattern may be: “It is important to identify the cause of deterioration of the problematic metric. Deterioration of the closure metric means that it takes more time to close defects while deterioration of the open metric indicates that backlog defects become older. It is especially worrying if deterioration of one or both percentile metrics is combined with deterioration of backlog size or if both percentile metrics deteriorate simultaneously. Corrective measures should be taken to increase productivity (especially if the closure metric or backlog size deteriorate), and to address the older defects (especially, if the backlog age deteriorates). The process should be tightly monitored during the following time periods.”

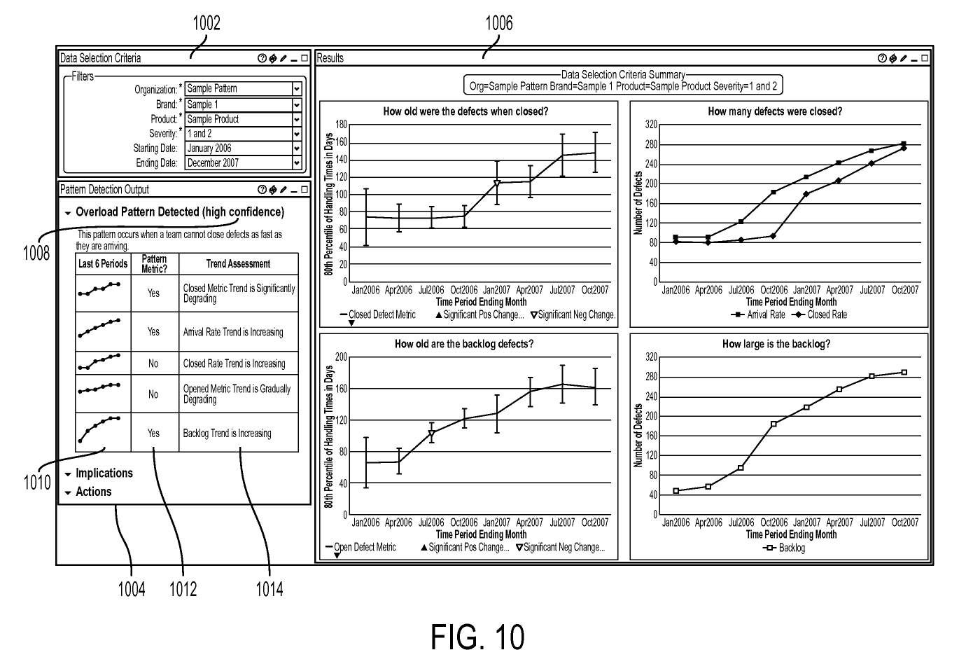

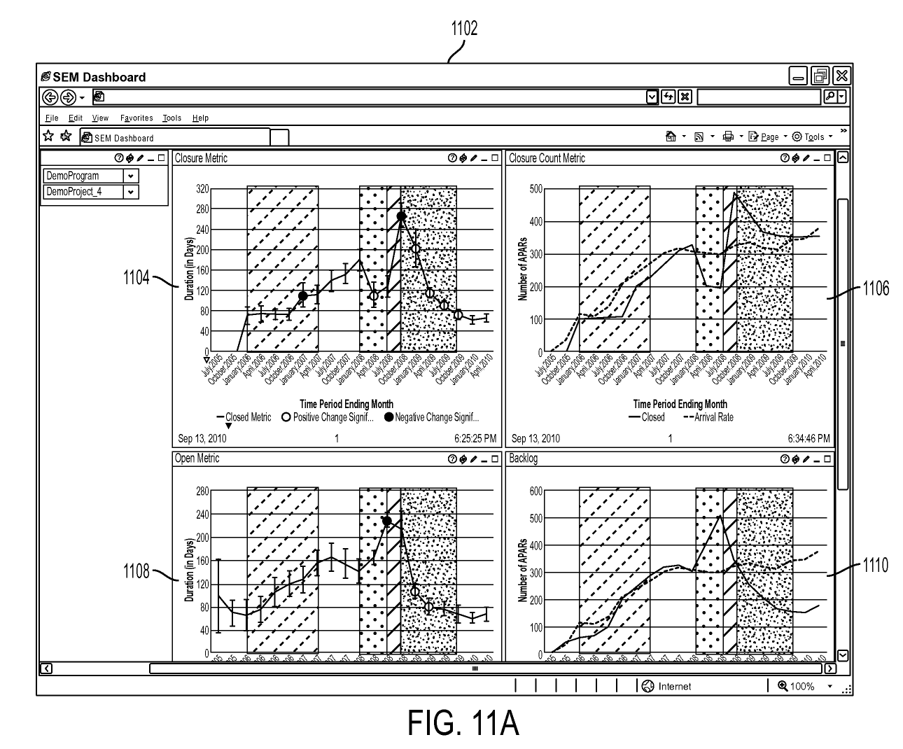

The graphical representation in FIG. 10 represents an approach, in one embodiment of the present disclosure, for analyzing the latest trends and then having the system translate them into potential business implications and suggested actions. The translation is accomplished by identifying the metric trends for a default number of periods (e.g., 6 periods) and then searching the pattern catalog for a match. If no match is found, the number of periods is decremented and the search continues until either a pattern is found or the minimum number of periods is reached (e.g., defined minimum such as 3 periods). Perform the analysis may include the following steps in one embodiment of the present disclosure:
1. Filter the data by changing the attribute values in the “Data Selection Criteria” panel (1002).
2. Review the charts plotting the metrics for the filtered data in the “Results” panel (1006).
3. Review the “Pattern Detection Output” panel (1004) which may include, but is not limited to, the following:
   a. The name of the pattern and the confidence level (1008), this confidence level may be computed based on the number of periods considered to locate a pattern (e.g., 6=high, 5 or 4=medium, 3=low).
   b. The column of charts plotting the trend for the considered number of periods.
   c. The column indicating whether the metric was used to identify the pattern (1012).
   d. The column identifying the metric and the type of trend plotted (1014)
4. Review the potential business implications and suggested actions defined by the pattern (1008).

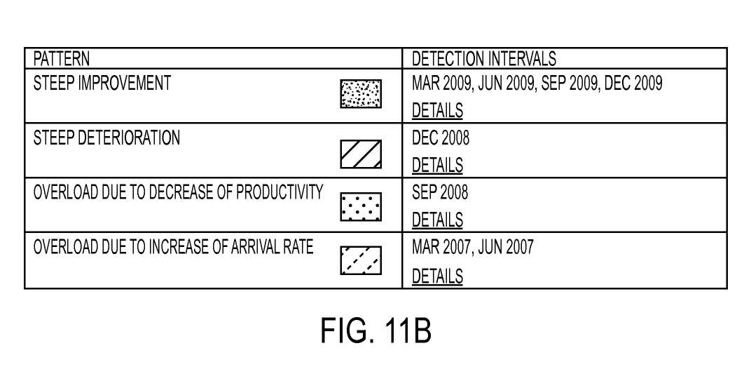

FIGS. 11A-11B show an example SEM dashboard 1102 in one embodiment of the present disclosure. For instance, at 1104, closure metric is shown with the identified SEM patterns as bars overlaid on the graph. Similarly, at 1106, closure count metric is shown with the identified SEM patterns. Likewise at 1108, open metric is shown with the identified SEM patterns. At 1110, backlog metric is shown with the identified SEM patterns. The dashboard 1102 may further allow a user to view details of the identified patterns, for example, via a link. Legend to the items shown on the dashboard is shown in FIG. 11B. Although FIG. 11A shows a graph of problem tickets over time overlaid with bars representing patterns detected over various intervals during the displayed time period, one skilled in the art will appreciate that one or more patterns could be displayed simultaneously on the same graph or the user could filter which patterns should be displayed at a given time.

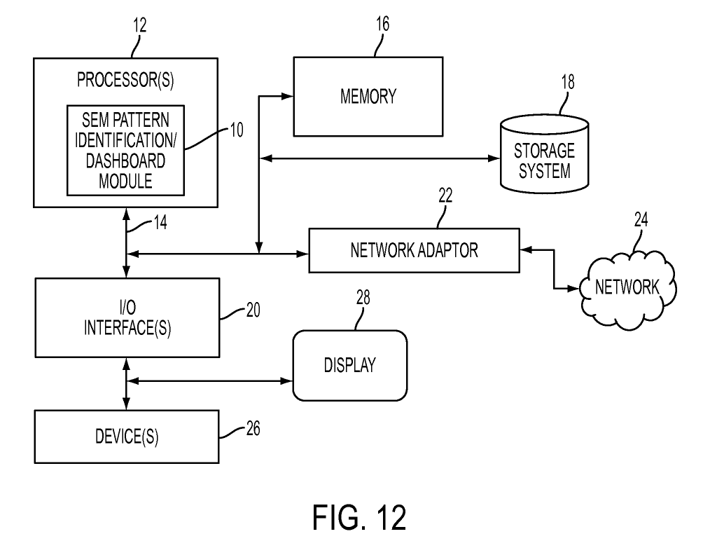

FIG. 12 illustrates a schematic of an example computer or processing system that may implement the SEM pattern identification system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 12 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a SEM pattern identification module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method for supporting problem resolution of an organization, comprising:
obtaining operational data associated with the organization;
calculating operating metrics based on the operational data;
detecting, by the processor, one or more metrics trends based on the calculated operational metrics;
identifying one or more relations between the metric trends; and
determining, by the processor, one or more SEM patterns from two or more of the calculated operational metrics and metric trends.

2. The method of claim 1, further including:
determining one or more remedial actions for addressing the determined SEM patterns.

3. The method of claim 1, wherein the operational data includes receipt and resolution time of defects in the organization.

4. The method of claim 1, wherein the calculated operating metrics include closure metric identifying time duration in which first predetermined percentile of defects have been closed, open metric identifying age of second predetermined percentile of defects that remain open, closure count metric identifying total number of defects, arrival rate metric identifying total number defects opened, and backlog metric identifying total number of defect that remain opened.

5. The method of claim 1, further including selecting a range of time periods for the SEM patterns.

6. The method of claim 1, further including determining one or more causes for the one or more SEM patterns.

7. The method of claim 1, further receiving a change in criteria for determining said SEM patterns from a user.

8. The method of claim 1, wherein the remedial action includes a prioritized list of actions for said one or more SEM patterns.

9. The method of claim 1, wherein the SEM patterns include one or more of:
stable;
seasonal;
efficiency deterioration;
efficiency improvement;
closure metric deterioration due to possible focus on old defects; or overload, or combinations thereof.

10. The method of claim 9, wherein a given overload pattern instance is further classified as to whether it is overload due to increase of arrival rate or overload due to decrease in productivity.

11. The method of claim 9, wherein a given efficiency deterioration pattern instance can be further classified into gradual or steep efficiency deterioration patterns.

12. The method of claim 9, wherein a given efficiency improvement pattern instance can be further classified into gradual or steep efficiency improvement patterns.

13. The method of claim 1, wherein the determining the SEM patterns further includes ranking the SEM patterns according to their severity.

14. The method of claim 1, further including displaying the calculated operating metrics simultaneously via a GUI and indicating the determined one or more patterns in the displayed metrics.

15. The method of claim 1, wherein a first user provides services of identifying said SEM patterns to a second user.

16. The method of claim 15, wherein an extent of the SEM patterns provided by the first user to the second is determined by a service contract between the first user and the second users.

17. The method of claim 15, wherein the first user offers to search for new additional SEM Patterns for the second user.

18. The method of claim 1, wherein the determined SEM patterns are included in a service level agreement.

19. The method of claim 18, wherein a resolution to one or more of the determined SEM patterns is included in the service level agreement.

20.-25. (canceled)
